(19) United States
(12) Patent Application Publication
(10) Pub. No.: US 2025/0184846 A1
(43) Pub. Date: Jun. 5, 2025

(54) SIGNALING SLICE INFORMATION TO A DEVICE

(71) Applicant: Lenovo (Singapore) Pte. Limited, Singapore (SG)

(72) Inventor: Prateek Basu Mallick, Dreieich (DE)

(73) Assignee: Lenovo (Singapore) Pte. Limited, Singapore (SG)

(21) Appl. No.: 18/725,693

(22) PCT Filed: Feb. 23, 2023
(86) PCT No.: PCT/IB2023/051650

§ 371 Date: Jun. 28, 2024

Related U.S. Application Data
(60) Provisional application No. 63/324,385, filed on Mar. 28, 2022.

(51) Int. Cl. H04W 36/00; H04W 36/24; H04W 48/10

(52) U.S. Cl. CPC H04W 36/13; H04W 36/24; H04W 48/10

(57) ABSTRACT

Various aspects of the present disclosure relate to a device (e.g., a user equipment (UE)) that receives dedicated signaling and broadcast signaling to communicate slice information to the device. The dedicated signaling includes, for each of one or more frequencies, identifiers of slice groups supported by the frequency and cell reselection priorities corresponding to the slice groups. These cell reselection priorities overwrite or take the place of cell reselection priorities received in the broadcast signaling. Other information received in the broadcast signaling, including an allowed list (which lists one or more cells supporting a slice group) or an excluded list (which lists one or more cells that do not support a slice group), are used for slice based cell reselection.

### RELATED APPLICATION

This application claims priority to U.S. Patent Application Ser. No. 63/324,385 filed Mar. 28, 2022 entitled “Signaling Slice Information to a Device,” the disclosure of which is incorporated by reference herein in its entirety.

### TECHNICAL FIELD

The present disclosure relates to wireless communications, and more specifically to signaling network slice information to a device, such as a user equipment (UE).

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, such as time resources (e.g., symbols, slots, subslots, mini-slots, aggregated slots, subframes, frames, or the like) or frequency resources (e.g., subcarriers, carriers). Additionally, the wireless communications system may support wireless communications across various radio access technologies (RATs) including third generation (3G) RAT, fourth generation (4G) RAT, fifth generation (5G) RAT, and other suitable RATs beyond 5G. In some cases, a wireless communications system may be a non-terrestrial network (NTN), which may support various communication devices for wireless communications in the NTN. For example, an NTN may include network entities onboard non-terrestrial vehicles such as satellites, unmanned aerial vehicles (UAV), and high-altitude platforms systems (HAPS), as well as network entities on the ground, such as gateway entities capable of transmitting and receiving over long distances.

A wireless communications system may support network slicing. Network slicing refers to a network architecture in which multiple logical networks are multiplexed on a physical network infrastructure. The different network slices (also referred to as simply slices) can be suited to different use cases, such as supporting different quality of service (QOS) levels or requirements.

### SUMMARY

The present disclosure relates to methods, apparatuses, and systems that support signaling slice information to a device. In one or more implementations, dedicated signaling includes, for each of one or more frequencies, identifiers of slice groups supported by the frequency and cell reselection priorities corresponding to the slice groups. These cell reselection priorities overwrite or take the place of cell reselection priorities received in broadcast signaling. Other information received in the broadcast signaling, including an allowed list (which lists one or more cells supporting a slice group) or an excluded list (which lists one or more cells that do not support a slice group), are used for slice based cell reselection. If a frequency is identified in only one of the dedicated signaling and the broadcast signaling, a cell reselection priority corresponding to the frequency may be used regardless of whether the cell reselection priority was identified in the dedicated signaling or the broadcast signaling.

By utilizing the described techniques, a device (e.g., a UE) is able to receive slice information via dedicated signaling and broadcast signaling and perform slice based cell reselection despite any ambiguities or inconsistencies that may be present due to receiving the slice information via the two types of signaling.

Some implementations of the method and apparatuses described herein may include wireless communication at a device (e.g., a UE), and the device receives, from a base station using broadcast signaling, a first signaling indicating first slice information and a first cell list, the first slice information identifying one or more slice groups supported by a frequency, and the first cell list identifying a first one or more cells supporting the one or more slice groups; receives, from the base station using dedicated signaling, a second signaling indicating second slice information that identifies one or more slice groups supported by the frequency; generates combined slice information by combining the first slice information and the second slice information; and performs, based on the combined slice information and the first cell list, slice based cell reselection.

In some implementations of the method and apparatuses described herein, the first slice information includes a first cell reselection priority corresponding to one slice group of the one or more slice groups for the frequency, and the second slice information includes a second cell reselection priority corresponding to the one slice group, and the device further generates the combined slice information by including in the combined slice information the second cell reselection priority corresponding to the one slice group rather than the first cell reselection priority corresponding to the one slice group. Additionally or alternatively, the device further generates the combined slice information by including in the combined slice information, the first cell list and all slice information in the first slice information other than the first cell reselection priority corresponding to the one slice group. Additionally or alternatively, the first slice information includes a frequency priority mapping for each of multiple slice groups supported by a current serving cell for the apparatus or by at least one neighboring cell. Additionally or alternatively, the second signaling comprises a radio resource control (RRC) Release message. Additionally or alternatively, the first cell list is an allowed list that lists one or more cells supporting the one or more slice groups. Additionally or alternatively, the first cell list is an excluded list that lists one or more cells that do not support the one or more slice groups. Additionally or alternatively, the first signaling indicates, for each of a first set of multiple frequencies, the first slice information and the first cell list, the first slice information identifying one or more slice groups supported by the frequency, and the first cell list identifying the first one or more cells supporting the one or more slice groups for the frequency. Additionally or alternatively, the second signaling indicates, for each of a second set of multiple frequencies, the first slice information and the first cell list, the first slice information identifying one or more slice groups supported by the frequency, and the first cell list identifying the first one or more cells supporting the one or more slice groups for the frequency, and wherein the first set of multiple frequencies includes a particular frequency that is not included in the second set of multiple frequencies, and the device further performs, based on the combined slice information and the first cell list, slice based cell reselection without considering the particular frequency. Additionally or alternatively, the second signaling further includes a second cell list identifying one or more cells supporting the one or more slice groups, wherein the first cell list is one of an allowed list that lists the one or more cells supporting the one or more slice groups or an excluded list that lists the one or more cells that do not support the one or more slice groups, the second cell list is the other of the allowed list or the excluded list, and the device further performs, based on the combined slice information, the first cell list, and the second cell list, slice based cell reselection. Additionally or alternatively, the second signaling further includes a second cell list identifying one or more cells supporting the one or more slice groups, wherein the first cell list is one of an allowed list that lists the one or more cells supporting the one or more slice groups or an excluded list that lists the one or more cells that do not support the one or more slice groups, the second cell list is the other of the allowed list or the excluded list, and the device further: determines that a best ranked cell for the frequency is not listed in either of the first cell list or the second cell list; acquires, in response to the best ranked cell for the frequency not being listed in either of the first cell list or the second cell list, cell system information for the best ranked cell; performs, based on the combined slice information, the first cell list, and the cell system information for the best ranked cell, slice based cell reselection.

Some implementations of the method and apparatuses described herein may include wireless communication at a device (e.g., a base station), and the device transmits, to a UE using broadcast signaling, a first signaling indicating first slice information and a first cell list, the first slice information identifying one or more slice groups supported by a frequency, and the first cell list identifying a first one or more cells supporting the one or more slice groups; and transmits, to the UE using dedicated signaling, a second signaling indicating second slice information that identifies one or more slice groups supported by the frequency.

In some implementations of the method and apparatuses described herein, the first slice information includes a frequency priority mapping for each of multiple slice groups supported by a current serving cell for the UE or by at least one neighboring cell. Additionally or alternatively, the first slice information includes a first cell reselection priority corresponding to one slice group of the one or more slice groups for the frequency, and the second slice information includes a second cell reselection priority corresponding to the one slice group. Additionally or alternatively, the second signaling comprises a RRC Release message. Additionally or alternatively, the first cell list is an allowed list that lists one or more cells supporting the one or more slice groups. Additionally or alternatively, the first cell list is an excluded list that lists one or more cells that do not support the one or more slice groups. Additionally or alternatively, the first signaling indicates, for each of a first set of multiple frequencies, the first slice information and the first cell list, the first slice information identifying one or more slice groups supported by the frequency, and the first cell list identifying the first one or more cells supporting the one or more slice groups for the frequency. Additionally or alternatively, the second signaling indicates, for each of a second set of multiple frequencies, the first slice information and the first cell list, the first slice information identifying one or more slice groups supported by the frequency, and the first cell list identifying the first one or more cells supporting the one or more slice groups for the frequency, and wherein the first set of multiple frequencies includes a particular frequency that is not included in the second set of multiple frequencies. Additionally or alternatively, the second signaling further receives a second cell list identifying one or more cells supporting the one or more slice groups, wherein the first cell list is one of an allowed list that lists the one or more cells supporting the one or more slice groups or an excluded list that lists the one or more cells that do not support the one or more slice groups, and the second cell list is the other of the allowed list or the excluded list.

### BRIEF DESCRIPTION OF THE DRAWINGS

Various aspects of the present disclosure for signaling slice information to a device are described with reference to the following Figures. The same numbers may be used throughout to reference like features and components shown in the Figures.

FIG. 1 illustrates an example of a wireless communications system that supports signaling slice information to a device in accordance with aspects of the present disclosure.

FIG. 2 illustrates an example of cell and frequency deployment as related to signaling slice information to a device.

FIG. 3 illustrates an example of transmitting dedicated information and broadcast information to a UE that supports signaling slice information to a device in accordance with aspects of the present disclosure.

FIG. 4 illustrates an example of slice information for dedicated signaling that supports signaling slice information to a device in accordance with aspects of the present disclosure.

FIG. 5 illustrates an example of slice information for broadcast signaling that supports signaling slice information to a device in accordance with aspects of the present disclosure.

FIG. 6 illustrates an example block diagram of components of a device (e.g., a UE) that supports signaling slice information to a device in accordance with aspects of the present disclosure.

FIG. 7 illustrates an example block diagram of components of a device (e.g., a base station that supports signaling slice information to a device in accordance with aspects of the present disclosure.

FIGS. 8, 9, 10, and 11 illustrate flowcharts of methods that support signaling slice information to a device in accordance with aspects of the present disclosure.

### DETAILED DESCRIPTION

Implementations of signaling slice information to a device are described, such as related to using dedicated signaling and broadcast signaling to communicate slice information to a device, such as a UE. The dedicated signaling includes, for each of one or more frequencies, identifiers of slice groups supported by the frequency and cell reselection priorities corresponding to the slice groups. These cell reselection priorities overwrite or take the place of cell reselection priorities received in the broadcast signaling. Other information received in the broadcast signaling, including an allowed list (which lists one or more cells supporting a slice group) or an excluded list (which lists one or more cells that do not support a slice group), are used for slice based cell reselection. Having the allowed list or excluded list in the broadcast signaling alleviates the need to duplicate the lists in the dedicated signaling, reducing the amount of signaling that is provided to the UEs, especially in situations in which the lists are unlikely to vary for different UEs.

Additionally or alternatively, if a frequency is identified in only one of the dedicated signaling and the broadcast signaling, a cell reselection priority corresponding to the frequency may be used regardless of whether the cell reselection priority was identified in the dedicated signaling or the broadcast signaling.

Additionally or alternatively, the information in the dedicated signaling takes precedence over information in the broadcast signaling. For example, if one or more slice groups supported by a particular frequency are identified in the broadcast signaling but no slice groups for the particular frequency are included in the dedicated signaling, the UE does not consider that particular frequency as a usable frequency for slice based cell reselection or considers that particular frequency as the lowest priority frequency.

Thus, using the techniques discussed herein, a device (e.g., a UE) is able to receive slice information via dedicated signaling and broadcast signaling and perform slice based cell reselection despite any ambiguities or inconsistencies that may be present due to receiving the slice information via the two types of signaling. This enables efficient signaling from the network perspective since the network need not repeat information from broadcast signaling into the dedicated signaling and in addition, it provides flexibility to the network operator since it can signal information most relevant to a particular UE, different from what has been signaled in the broadcast, in the dedicated signaling.

Aspects of the present disclosure are described in the context of a wireless communications system. Aspects of the present disclosure are further illustrated and described with reference to device diagrams and flowcharts that relate to signaling slice information to a device.

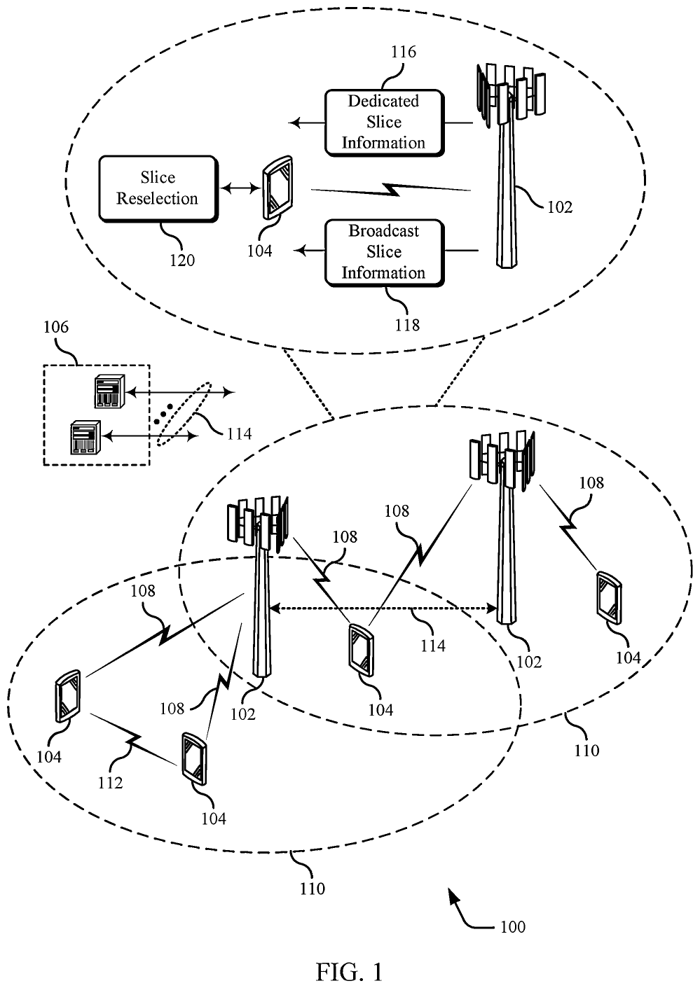

FIG. 1 illustrates an example of a wireless communications system 100 that supports signaling slice information to a device in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be, or include, or may be referred to as a base transceiver station, an access point, a NodeB, an eNodeB (eNB), a next-generation NodeB (gNB), a Radio Head (RH), a relay node, an integrated access and backhaul (IAB) node, or other suitable terminology. A base station 102 and a UE 104 may communicate via a communication link 108, which may be a wireless or wired connection. For example, a base station 102 and a UE 104 may perform wireless communication over a NR-Uu interface.

A base station 102 may provide a geographic coverage area 110 for which the base station 102 may support services (e.g., voice, video, packet data, messaging, broadcast, etc.) for one or more UEs 104 within the geographic coverage area. For example, a base station 102 and a UE 104 may support wireless communication of signals related to services (e.g., voice, video, packet data, messaging, broadcast, etc.) according to one or multiple radio access technologies. In some implementations, a base station 102 may be moveable, such as when implemented as a gNB onboard a satellite or other non-terrestrial station (NTS) associated with a non-terrestrial network (NTN). In some implementations, different geographic coverage areas 110 associated with the same or different radio access technologies may overlap, and different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region or coverage area 110 of the wireless communications system 100. A UE 104 may include or may be referred to as a mobile device, a wireless device, a remote device, a handheld device, a customer premise equipment (CPE), a subscriber device, or as some other suitable terminology. In some implementations, the UE 104 may be referred to as a unit, a station, a terminal, or a client, among other examples. Additionally, or alternatively, a UE 104 may be referred to as an Internet-of-Things (IoT) device, an Internet-of-Everything (IoE) device, or as a machine-type communication (MTC) device, among other examples. In some implementations, a UE 104 may be stationary in the wireless communications system 100. In other implementations, a UE 104 may be mobile in the wireless communications system 100, such as an earth station in motion (ESIM).

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, a gateway device, an integrated access and backhaul (IAB) node, a location server that implements the location management function (LMF), or other network equipment). Additionally, or alternatively, a UE 104 may support communication with other base stations 102 or UEs 104, which may act as relays in the wireless communications system 100.

A UE 104 may also support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, or other network interface). The base stations 102 may communicate with each other over the backhaul links 114 (e.g., via an X2, Xn, or another network interface). In some implementations, the base stations 102 may communicate with each other directly (e.g., between the base stations 102). In some other implementations, the base stations 102 may communicate with each other indirectly (e.g., via the core network 106). In some implementations, one or more base stations 102 may include subcomponents, such as an access network entity, which may be an example of an access node controller (ANC). The ANC may communicate with the one or more UEs 104 through one or more other access network transmission entities, which may be referred to as remote radio heads, smart radio heads, gateways, transmission-reception points (TRPs), and other network nodes and/or entities.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)), and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

According to implementations, one or more of the UEs 104 and base stations 102 are operable to implement various aspects of signaling slice information to a device, as described herein. For instance, a base station 102 can communicate dedicated slice information 116 and broadcast slice information 118, both of which include various information regarding slices in wireless communications system 100, such as information to facilitate slice selection or reselection. The dedicated slice information 116 is slice information directed to or intended for a single UE 104, whereas the broadcast slice information 118 is slice information directed to or intended for multiple UEs 104. A UE 104 receives and uses the dedicated slice information 116 and the broadcast slice information 118 to perform a slice reselection process 120 as discussed in more detail below.

In aspects of this disclosure, supporting slice based cell reselection, including specifying mechanisms and signaling is taken into consideration. This may include, to assist cell reselection, broadcasting the supported slice information of the current serving cell and neighboring cells, and cell reselection priority per slice in system information (SI) message. To assist cell reselection, including slice information (with similar information as in SI message) in, for example, an RRCRelease message. A neighboring cell refers to a cell that is near the current serving cell and may become the new current serving cell as a result of cell reselection.

In aspects of this disclosure, 3rd Generation Partnership Project (3GPP) Technical Specification Group Radio Access Network (TSG RAN), 3GPP TSG RAN WG2 (RAN2), is taken into consideration. This may include the slice single-network slice selection assistance information (S-NSSAI) based cell reselection, e.g., as defined in 3GPP technical specification (TS) 38.331.

In aspects of this disclosure, the UE 104 determining the frequency priority order according to the following rules is taken into consideration. These rules may include at least one of considering the slice/slice group priority provided by NAS, the frequencies that support higher priority slice/slice group have higher slice based frequency priority than the frequencies that support lower priority slice/slice group; among the frequencies supporting a slice/slice group with the same priority, the UE should follow the slice specific frequency priority received in SIB or RRCRelease (if configured); among the frequencies supporting the same slice/slice group, the frequency not configured with slice specific reselection priority should be considered as lower priority than other frequencies configured with slice specific reselection priority; the frequencies that support any slice/slice group have higher slice based frequency priority than the frequencies that support none of slice/slice group; or for the frequencies that do not support any slice/slice group, the UE should follow the legacy cell reselection priority received in SIB, FFS when only legacy priority received in RRCRelease.

In aspects of this disclosure, if the UE 104 is configured with slice specific frequency priority via RRCRelease message, the UE 104 shall ignore all the slice specific priorities provided in system information is taken into consideration. This may include applying the legacy cell reselection frequency priorities in SIB.

In aspects of this disclosure, the legacy procedure (i.e., the UE 104 first enters any cell selection state and performs cell selection) should be reused when the UE 104 cannot find a suitable cell using any cell reselection priorities (including slice-based and legacy (non-slice based) priorities) if the UE is configured with slice based dedicated priority is taken into consideration.

In aspects of this disclosure, inter-RAT frequencies are not configured with slice specific frequency priority, but inter-RAT frequencies can be considered using legacy cell reselection frequency priority after all NR frequencies that support any slice/slice group is taken into consideration.

In aspects of this disclosure, the slice specific cell reselection information provided by the network in SIB is slice group specific is taken into consideration. This may include

In aspects of this disclosure, reusing the legacy T320 timer for slice specific frequency priority in RRCRelease is taken into consideration.

In aspects of this disclosure, RAN sharing can be supported for slice based cell reselection and random access channel (RACH) by network implementation (e.g., dedicated priorities in RRCRelease) is taken into consideration. This may include not having defined public land mobile network (PLMN)-specific reselection priorities or RACH configuration, and may include having something extra in RACH (may not be critical to WI completion).

In aspects of this disclosure, a frequency being sorted multiple times, or only once, or it is up to the UE 104 implementation is taken into consideration.

In aspects of this disclosure, the slice group specific cell reselection information being provided by the network in RRCRelease is taken into consideration. This may include

In aspects of this disclosure, re-sorting is defined as a change of frequency priority for reselection of a certain frequency requiring the UE 104 to re-sort the ordered list of frequencies is taken into consideration. This may include principles for slice-specific reselection, and that change of priority for slice-specific reselection does not impact existing RAN4 radio resource management (RRM) requirements.

In aspects of this disclosure, a re-sorting is applied if the UE 104 performs slice-based cell reselection and if the highest ranked cell of the said frequency, according to neighboring cell information, does not support the highest priority slice supported by its frequency is taken into consideration.

In aspects of this disclosure, the UE 104 behavior for frequencies determined as “equal priority” is defined similar to UE behavior for the case of equal priority NR frequencies in 5.2.4.6 (“Intra-frequency and equal priority inter-frequency Cell Reselection criteria”) of 3GPP TS 38.304 is taken into consideration.

In aspects of this disclosure, physical cell identifier (PCI) list per slice group per frequency can be provided in system information is taken into consideration.

In aspects of this disclosure, the network (e.g., a base station 102) can indicate whether the PCI list is block-list (“cells not supporting the corresponding slice group”) or allow-list (“cells supporting the corresponding slice group”) is taken into consideration.

In aspects of this disclosure, the assumption that the mapping of slice to the slice groups for cell reselection are per tracking area (TA) is taken into consideration.

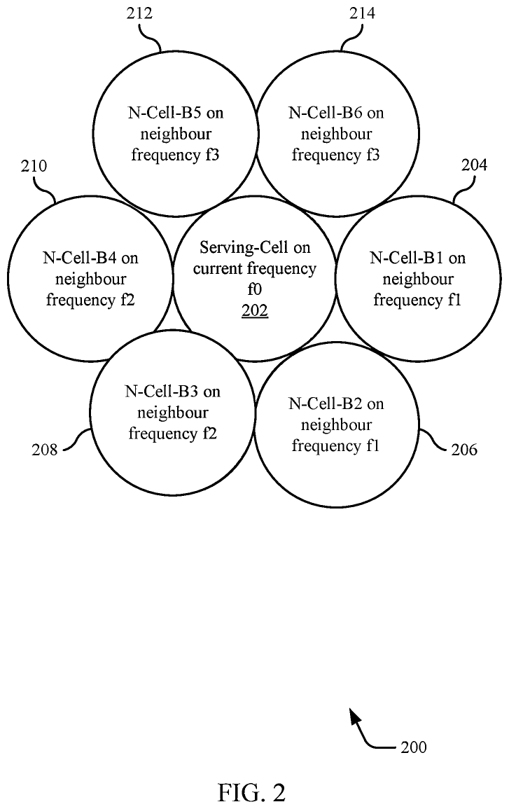

FIG. 2 illustrates an example of cell and frequency deployment 200 as related to signaling slice information to a device. With reference to FIG. 2, the example cell and frequency deployment 200 includes a cell that is currently serving a UE 104 on a frequency f0, illustrated as serving-cell 202. Multiple neighboring cells are also illustrated with the abbreviation “N-Cellx” where “x” is a number. Neighboring cell 204 is illustrated as operating on frequency f1, neighboring cell 206 is illustrated as operating on frequency f1, neighboring cell 208 is illustrated as operating on frequency f2, neighboring cell 210 is illustrated as operating on frequency f2, neighboring cell 212 is illustrated as operating on frequency f3, and neighboring cell 214 is illustrated as operating on frequency f3. In aspects of the disclosure, the rules and considerations above and elsewhere herein govern how the UE 104 performs slice based reselection.

A UE 104 is given one or more slice groups by its NAS. Each slice group may include one or more slices. These slice groups may have different priority and the UE 104 aims to reselect to a cell supporting its highest priority slice group. For this purpose, the UE 104 uses information including the slice(s)/slice group(s) supported in neighboring cells. The slice reselection information (also referred to as slice info) is used for this purpose. The slice information is defined as a frequency priority mapping for each of the slice groups (slice group->frequency(ies)->absolute priority of each of the frequency) and therefore consists of these 3 elements (slice group, frequency, and an absolute frequency priority). The absolute priority of a frequency is also referred to as the CellReselectionPriority (CRP) or the CellReselectionSubPriority. In the discussions herein, reference to CRP may refer to the CellReselectionPriority, the CellReselectionSubPriority, or both the CellReselectionPriority and the CellReselectionSubPriority.

The slice info (for a slice or slice group) can be provided using either or both broadcast and dedicated signaling. Absolute priorities of different NR frequencies or inter-RAT frequencies may be provided to the UE in the system information, in the RRCRelease message, or by inheriting from another RAT at inter-RAT cell (re) selection. In the case of system information, an NR frequency or inter-RAT frequency may be listed without providing a priority (i.e., the field cellReselectionPriority is absent for that frequency). If any fields with cellReselectionPriority are provided in dedicated signaling, the UE shall ignore any fields with cellReselectionPriority and any slice reselection information provided in system information. If slice reselection information is provided in dedicated signaling, the UE shall ignore slice reselection information provided in system information (e.g., system information block (SIB)).

Aspects of the present disclosure include solutions to describe if and how information provided in RRCRelease overrides information provided in SIB. This includes slice-specific reselection information, existing/legacy cellReselectionPriority. Aspects of the present disclosure include solutions to describe whether providing PCI lists are provided in RRCRelease and when so, what will the UE 104 behavior is (e.g., which cell list will the UE 104 use). The PCI lists include one or both of an allowed list (which lists one or more cells supporting a slice group) or an excluded list (which lists one or more cells that do not support a slice group).

The cell Identity information provided by the serving cell can be very signaling inefficient since there can be as many as 96 such entries (12 cells*8 frequencies) of at least 10 bit cell identity, especially if this information is repeated in both broadcast and dedicated signaling.

In one solution, slice support information of each cell on each neighboring frequency is provided by the serving cell using both broadcast and dedicated signaling. However, this solution can be very signaling inefficient since there can be, for example, as many as 96 such entries (12 cells*8 frequencies) of 10 bit cell identity, for which slice group support would need to be indicated and most of this information may be overlapping. This solution is further signaling inefficient if this information is repeated in both broadcast and dedicated signaling.

Although portions of the present disclosure may mention only “slice” or “slice group,” the revealed methods, implementations, or techniques are equally applicable to both a “slice” and a “slice group”. A slice group consists of one or multiple slices, one slice belongs to one and only one slice group for cell reselection purpose (so, there may be another slice to slice group mapping for RACH configuration and partitioning purpose), and each slice group is uniquely identified by a slice group identifier. This can avoid publishing slice identities (S-NSSAI) in the system information (e.g., due to security concern and system information size concern). The signaling of such slice grouping and slice group identity can be indicated, for example, in NAS signaling to the UE 104.

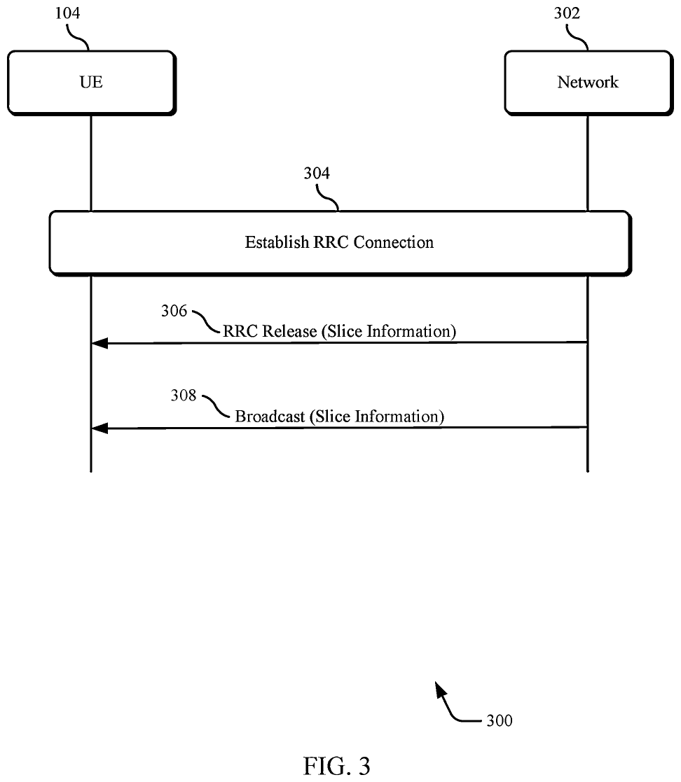

FIG. 3 illustrates an example 300 of transmitting dedicated information and broadcast information to a UE that supports signaling slice information to a device in accordance with aspects of the present disclosure. Both dedicated and broadcast information can contain part of the slice information to a UE 104. In the example 300, a network 302 (e.g., a network device such as a base station 102) and a UE 104 transmit signals to one another. An RRC connection 304 is established between the network 302 and the UE 104. The network 302 uses direct signaling, illustrated as an RRCRelease message 306, to transmit slice information to the UE 104. The network 302 also uses broadcast signaling 308 to transmit slice information to the UE 104.

In one or more implementations, the RRCRelease message 306 contains only sliceGroup-CRPs for one or more frequencies. These sliceGroup-CRPs overwrite or replace the priority received in broadcast message signaling 308 for the corresponding slice group-frequency pair. All other information is taken from the broadcasted information (the broadcast signaling 308) including allowed (sliceAllowCellListNR) cell list and blocked (sliceExcludeCellListNR) cell list. For a frequency (or frequencies) that appears only in one of the lists (i.e., in the RRCRelease message 306 or in broadcast signaling 308), the frequency is retained by the UE 104 (e.g., the frequency priority corresponding to the frequency is used irrespective of if the received information is from the RRCRelease message 306 or the broadcast signaling 308).

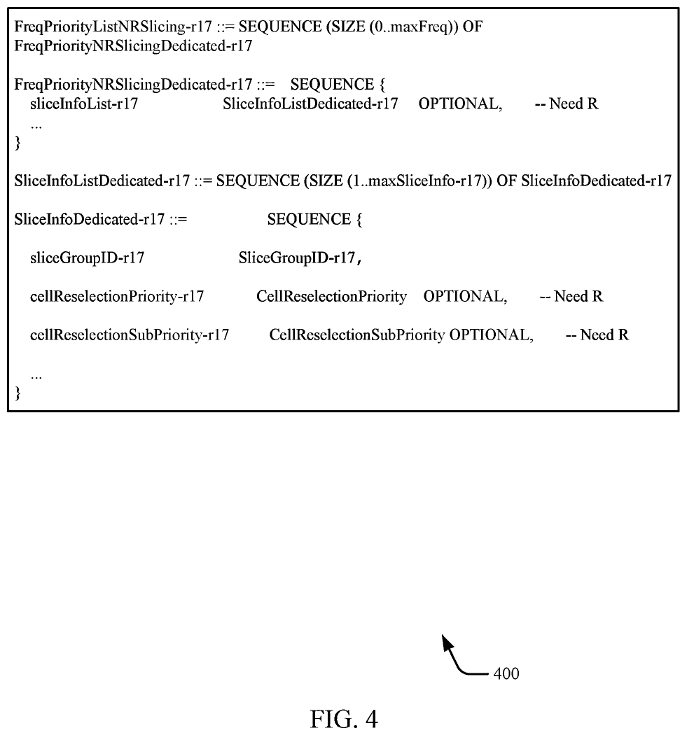

FIG. 4 illustrates an example 400 of slice information for dedicated signaling that supports signaling slice information to a device in accordance with aspects of the present disclosure. As illustrated in the example 400, the slice information for dedicated signaling includes a sequence of multiple frequencies with indications of one or more slice groups supported by the frequency and cell reselection priorities corresponding to the slice.

In the example 400, some information elements are illustrated as optional and have a corresponding code, such as “--Need R”. These corresponding codes indicate the behavior of the UE 104 in situations where the corresponding data is not included in the dedicated signaling. For example, such a corresponding code may indicate to the UE 104 to continue using whatever data the UE 104 already has for that information element, may indicate to delete any data the UE 104 already has for that information element, and so forth. Any of various codes can be used as discussed in 3GPP TS 38.331.

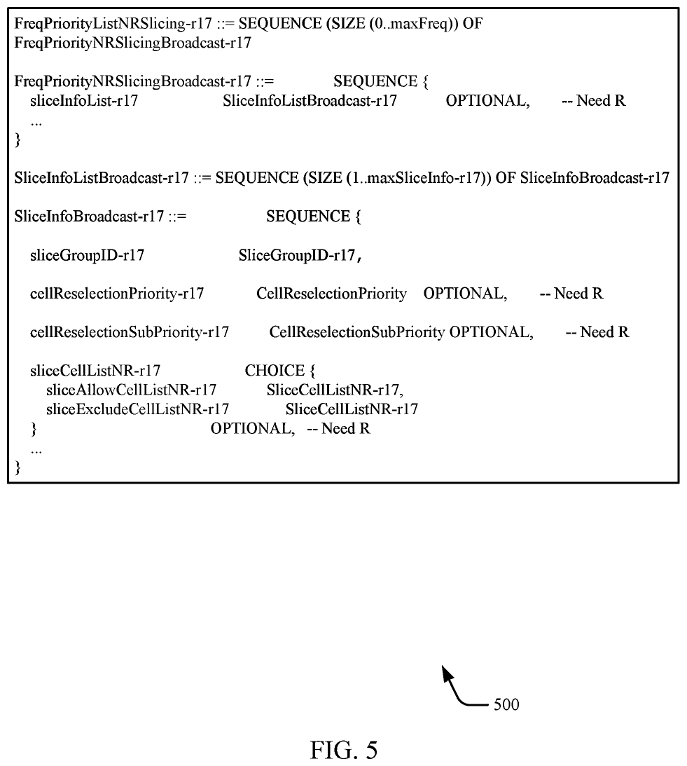

FIG. 5 illustrates an example 500 of slice information for broadcast signaling that supports signaling slice information to a device in accordance with aspects of the present disclosure. As illustrated in the example 500, the slice information for broadcast signaling includes a sequence of multiple frequencies with indications of one or more slice groups supported by the frequency and cell reselection priorities corresponding to the slice. The slice information for broadcast signaling also includes an allowed list (which lists one or more cells supporting a slice group) or an excluded list (which lists one or more cells that do not support a slice group). The excluded list may also be referred to as a block list or a blocked list corresponding to each frequency. In one or more implementations, the broadcast signaling may include, for each frequency, an allowed list or an excluded list but not both lists. Alternatively, the broadcast signaling may include, for each frequency, both an allowed list and an excluded list.

In the example 500, some information elements are illustrated as optional and have a corresponding code, such as “--Need R”. These corresponding codes indicate the behavior of the UE 104 in situations where the corresponding data is not included in the broadcast signaling. For example, such a corresponding code may indicate to the UE 104 to continue using whatever data the UE 104 already has for that information element, may indicate to delete any data the UE 104 already has for that information element, and so forth. Any of various codes can be used as discussed in 3GPP TS 38.331.

Returning to FIG. 3, in one or more implementations, the RRCRelease message 306 contains only sliceGroup-CRPs for one or more frequencies. These sliceGroup-CRPs overwrite or replace the priority received in the broadcast signaling 308 for the corresponding slice group-frequency pair. All other information is taken from the broadcasted information in the broadcast signaling 308, including allowed (sliceAllowCellListNR) cell list and blocked (sliceExcludeCellListNR) cell list. For a frequency (or frequencies) that does not appear in the RRCRelease message 306, the frequency (or frequencies) is not considered for cell reselection or considered as the lowest priority frequency. E.g., the UE 104 assumes that because the frequency (or frequencies) was not included in the dedicated signaling for the UE 104, the network 302 does not want the UE 104 using the frequency (or frequencies).

In one or more implementations, the cell lists (excluded list or allowed list) for a slice group-frequency pair received in the dedicated signaling will be used, if the cell lists are present in both the dedicated and broadcast signaling. However, if one of these signaling (the dedicated or the broadcast) provides one type of list (e.g., allowed list cells 1, 2) and the other signaling (the broadcast or the dedicated) provides another type of list (e.g., excluded list cell 5), or vice-versa, then both the received lists can be used simultaneously. That is, the UE 104 reselects a best ranked cell on a frequency if the cell is listed in the allowed list. But if the best (radio) ranked cell (e.g., based on RSRP or RSRQ measurement values) is listed in the excluded list, it does not consider the frequency for slice based reselections anymore until a reselection to another cell has been made or until information from NAS to AS on slice groups has changed or the slice info from broadcast signaling has changed. In addition, the UE 104 may need to acquire the system information of cells that do not appear in either of the lists, if such a cell is the best (radio) ranked cell on its frequency.

For example, assume the best ranked cell is cell_B for a frequency, which means that cell_B has the highest RSRP or RSRQ measurement values in that frequency. But if it happens that cell_B was included in the excluded list, which means that this frequency slice group pair for which the UE 104 was expecting to find on that frequency is not supported by this particular cell, the frequency might be supported by other cells, but unfortunately cell_B does not support the frequency. Accordingly, the UE 104 does not consider the frequency for slice based reselection any more until a reselection to another cell has been made or until information from NAS to AS on slice groups has changed or the slice information from the broadcast signaling has changed. So the UE 104 will not consider that frequency for slice based reselection until at least one of these three things has changed.

By way of another example, the slice information may include no information for a particular cell. E.g., assume the best ranked cell is cell_D, but the slice information in neither the RRCRelease message 306 nor the broadcast signaling 308 includes information regarding a cell_D. In such a situation the UE 104 acquires the system information on cell_D (e.g., from cell_D) to obtain the slice information for cell_D.

Accordingly, using the techniques described herein, in one or more implementations a new signaling method for signaling slice information is revealed. Additionally or alternatively, optimal cell list signaling and corresponding UE behavior is described. Additionally or alternatively, UE behavior is described when the best ranked cell on a frequency if the cell is listed in an excluded list.

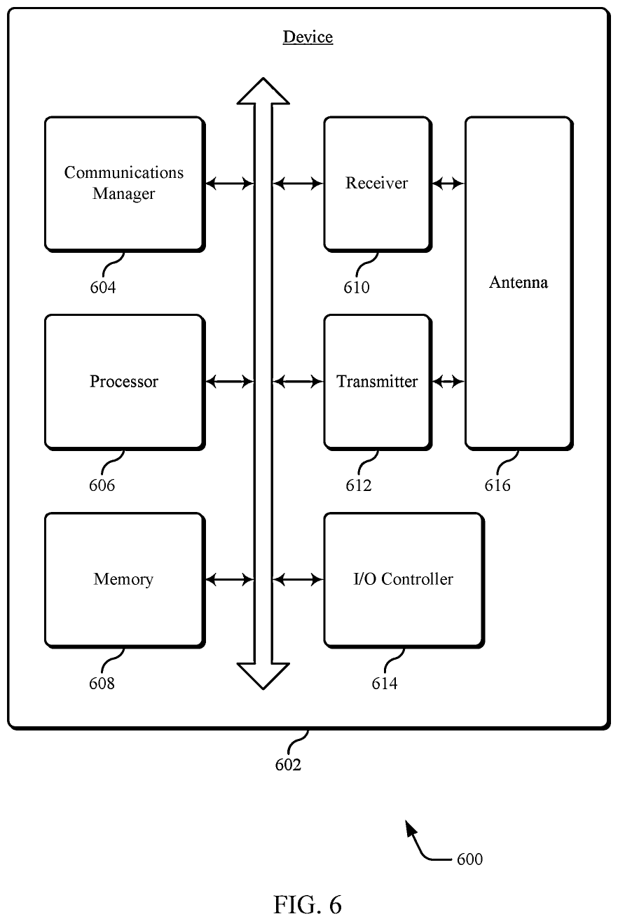

FIG. 6 illustrates an example of a block diagram 600 of a device 602 that supports signaling slice information to a device in accordance with aspects of the present disclosure. The device 602 may be an example of a UE 104 as described herein. The device 602 may support wireless communication and/or network signaling with one or more base stations 102, other UEs 104, network entities and devices, or any combination thereof. The device 602 may include components for bi-directional communications including components for transmitting and receiving communications, such as a communications manager 604, a processor 606, a memory 608, a receiver 610, a transmitter 612, and an I/O controller 614. These components may be in electronic communication or otherwise coupled (e.g., operatively, communicatively, functionally, electronically, electrically) via one or more interfaces (e.g., buses).

The communications manager 604, the receiver 610, the transmitter 612, or various combinations thereof or various components thereof may be examples of means for performing various aspects of the present disclosure as described herein. For example, the communications manager 604, the receiver 610, the transmitter 612, or various combinations or components thereof may support a method for performing one or more of the functions described herein.

In some implementations, the communications manager 604, the receiver 610, the transmitter 612, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 606 and the memory 608 coupled with the processor 606 may be configured to perform one or more of the functions described herein (e.g., by executing, by the processor 606, instructions stored in the memory 608).

Additionally or alternatively, in some implementations, the communications manager 604, the receiver 610, the transmitter 612, or various combinations or components thereof may be implemented in code (e.g., as communications management software or firmware) executed by the processor 606. If implemented in code executed by the processor 606, the functions of the communications manager 604, the receiver 610, the transmitter 612, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 604 may be configured to perform various operations (e.g., receiving, monitoring, transmitting) using or otherwise in cooperation with the receiver 610, the transmitter 612, or both. For example, the communications manager 604 may receive information from the receiver 610, send information to the transmitter 612, or be integrated in combination with the receiver 610, the transmitter 612, or both to receive information, transmit information, or perform various other operations as described herein. Although the communications manager 604 is illustrated as a separate component, in some implementations, one or more functions described with reference to the communications manager 604 may be supported by or performed by the processor 606, the memory 608, or any combination thereof. For example, the memory 608 may store code, which may include instructions executable by the processor 606 to cause the device 602 to perform various aspects of the present disclosure as described herein, or the processor 606 and the memory 608 may be otherwise configured to perform or support such operations.

For example, the communications manager 604 may support wireless communication and/or network signaling at a device (e.g., the device 602, a UE) in accordance with examples as disclosed herein. The communications manager 604 and/or other device components may be configured as or otherwise support an apparatus, such as a UE, including a transceiver; a processor coupled to the transceiver, the processor and the transceiver configured to cause the apparatus to: receive, from a base station using broadcast signaling, a first signaling indicating first slice information and a first cell list, the first slice information identifying one or more slice groups supported by a frequency, and the first cell list identifying a first one or more cells supporting the one or more slice groups; receive, from the base station using dedicated signaling, a second signaling indicating second slice information that identifies one or more slice groups supported by the frequency; generate combined slice information by combining the first slice information and the second slice information; and perform, based on the combined slice information and the first cell list, slice based cell reselection.

Additionally, the apparatus (e.g., a UE) includes any one or combination of: where the first slice information includes a first cell reselection priority corresponding to one slice group of the one or more slice groups for the frequency, and the second slice information includes a second cell reselection priority corresponding to the one slice group, and the processor and the transceiver are further configured to cause the apparatus to: generate the combined slice information by including in the combined slice information the second cell reselection priority corresponding to the one slice group rather than the first cell reselection priority corresponding to the one slice group; where the processor and the transceiver are further configured to cause the apparatus to: generate the combined slice information by including in the combined slice information, the first cell list and all slice information in the first slice information other than the first cell reselection priority corresponding to the one slice group; where the first slice information includes a frequency priority mapping for each of multiple slice groups supported by a current serving cell for the apparatus or by at least one neighboring cell; where the second signaling comprises a RRCRelease message; where the first cell list is an allowed list that lists one or more cells supporting the one or more slice groups; where the first cell list is an excluded list that lists one or more cells that do not support the one or more slice groups; where the first signaling indicates, for each of a first set of multiple frequencies, the first slice information and the first cell list, the first slice information identifying one or more slice groups supported by the frequency, and the first cell list identifying the first one or more cells supporting the one or more slice groups for the frequency; where the second signaling indicates, for each of a second set of multiple frequencies, the first slice information and the first cell list, the first slice information identifying one or more slice groups supported by the frequency, and the first cell list identifying the first one or more cells supporting the one or more slice groups for the frequency, and where the first set of multiple frequencies includes a particular frequency that is not included in the second set of multiple frequencies, the processor and the transceiver are further configured to cause the apparatus to: perform, based on the combined slice information and the first cell list, slice based cell reselection without considering the particular frequency; where the second signaling further includes a second cell list identifying one or more cells supporting the one or more slice groups, where the first cell list is one of an allowed list that lists the one or more cells supporting the one or more slice groups or an excluded list that lists the one or more cells that do not support the one or more slice groups, the second cell list is the other of the allowed list or the excluded list, and the processor and the transceiver are further configured to cause the apparatus to: perform, based on the combined slice information, the first cell list, and the second cell list, slice based cell reselection; where the second signaling further includes a second cell list identifying one or more cells supporting the one or more slice groups, where the first cell list is one of an allowed list that lists the one or more cells supporting the one or more slice groups or an excluded list that lists the one or more cells that do not support the one or more slice groups, the second cell list is the other of the allowed list or the excluded list, and the processor and the transceiver are further configured to cause the apparatus to: determine that a best ranked cell for the frequency is not listed in either of the first cell list or the second cell list; acquire, in response to the best ranked cell for the frequency not being listed in either of the first cell list or the second cell list, cell system information for the best ranked cell; perform, based on the combined slice information, the first cell list, and the cell system information for the best ranked cell, slice based cell reselection.

The communications manager 604 and/or other device components may be configured as or otherwise support a means for wireless communication and/or network signaling at a UE, including receiving, from a base station using broadcast signaling, a first signaling indicating first slice information and a first cell list, the first slice information identifying one or more slice groups supported by a frequency, and the first cell list identifying a first one or more cells supporting the one or more slice groups; receiving, from the base station using dedicated signaling, a second signaling indicating second slice information that identifies one or more slice groups supported by the frequency; generating combined slice information by combining the first slice information and the second slice information; and performing, based on the combined slice information and the first cell list, slice based cell reselection.

Additionally, wireless communication and/or network signaling at the UE includes any one or combination of: where the first slice information includes a first cell reselection priority corresponding to one slice group of the one or more slice groups for the frequency, and the second slice information includes a second cell reselection priority corresponding to the one slice group, and further including: generating the combined slice information by including in the combined slice information the second cell reselection priority corresponding to the one slice group rather than the first cell reselection priority corresponding to the one slice group; further including: generating the combined slice information by including in the combined slice information, the first cell list and all slice information in the first slice information other than the first cell reselection priority corresponding to the one slice group; where the first slice information includes a frequency priority mapping for each of multiple slice groups supported by a current serving cell for an apparatus implementing the method or by at least one neighboring cell; where the second signaling comprises a RRCRelease message; where the first cell list is an allowed list that lists one or more cells supporting the one or more slice groups; where the first cell list is an excluded list that lists one or more cells that do not support the one or more slice groups; where the first signaling indicates, for each of a first set of multiple frequencies, the first slice information and the first cell list, the first slice information identifying one or more slice groups supported by the frequency, and the first cell list identifying the first one or more cells supporting the one or more slice groups for the frequency; where the second signaling indicates, for each of a second set of multiple frequencies, the first slice information and the first cell list, the first slice information identifying one or more slice groups supported by the frequency, and the first cell list identifying the first one or more cells supporting the one or more slice groups for the frequency, and where the first set of multiple frequencies includes a particular frequency that is not included in the second set of multiple frequencies, the method further including: performing, based on the combined slice information and the first cell list, slice based cell reselection without considering the particular frequency; where the second signaling further includes a second cell list identifying one or more cells supporting the one or more slice groups, where the first cell list is one of an allowed list that lists the one or more cells supporting the one or more slice groups or an excluded list that lists the one or more cells that do not support the one or more slice groups, the second cell list is the other of the allowed list or the excluded list, the method further including: performing, based on the combined slice information, the first cell list, and the second cell list, slice based cell reselection; where the second signaling further includes a second cell list identifying one or more cells supporting the one or more slice groups, where the first cell list is one of an allowed list that lists the one or more cells supporting the one or more slice groups or an excluded list that lists the one or more cells that do not support the one or more slice groups, the second cell list is the other of the allowed list or the excluded list, the method further including: determining that a best ranked cell for the frequency is not listed in either of the first cell list or the second cell list; acquiring, in response to the best ranked cell for the frequency not being listed in either of the first cell list or the second cell list, cell system information for the best ranked cell; performing, based on the combined slice information, the first cell list, and the cell system information for the best ranked cell, slice based cell reselection.

The processor 606 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 606 may be configured to operate a memory array using a memory controller. In some other implementations, a memory controller may be integrated into the processor 606. The processor 606 may be configured to execute computer-readable instructions stored in a memory (e.g., the memory 608) to cause the device 602 to perform various functions of the present disclosure.

The memory 608 may include random access memory (RAM) and read-only memory (ROM). The memory 608 may store computer-readable, computer-executable code including instructions that, when executed by the processor 606 cause the device 602 to perform various functions described herein. The code may be stored in a non-transitory computer-readable medium such as system memory or another type of memory. In some implementations, the code may not be directly executable by the processor 606 but may cause a computer (e.g., when compiled and executed) to perform functions described herein. In some implementations, the memory 608 may include, among other things, a basic I/O system (BIOS) which may control basic hardware or software operation such as the interaction with peripheral components or devices.

The I/O controller 614 may manage input and output signals for the device 602. The I/O controller 614 may also manage peripherals not integrated into the device 602. In some implementations, the I/O controller 614 may represent a physical connection or port to an external peripheral. In some implementations, the I/O controller 614 may utilize an operating system such as iOS®, ANDROID®, MS-DOS®, MS-WINDOWS®, OS/2®, UNIX®, LINUX®, or another known operating system. In some implementations, the I/O controller 614 may be implemented as part of a processor, such as the processor 606. In some implementations, a user may interact with the device 602 via the I/O controller 614 or via hardware components controlled by the I/O controller 614.

In some implementations, the device 602 may include a single antenna 616. However, in some other implementations, the device 602 may have more than one antenna 616, which may be capable of concurrently transmitting or receiving multiple wireless transmissions. The receiver 610 and the transmitter 612 may communicate bi-directionally, via the one or more antennas 616, wired, or wireless links as described herein. For example, the receiver 610 and the transmitter 612 may represent a wireless transceiver and may communicate bi-directionally with another wireless transceiver. The transceiver may also include a modem to modulate the packets, to provide the modulated packets to one or more antennas 616 for transmission, and to demodulate packets received from the one or more antennas 616.

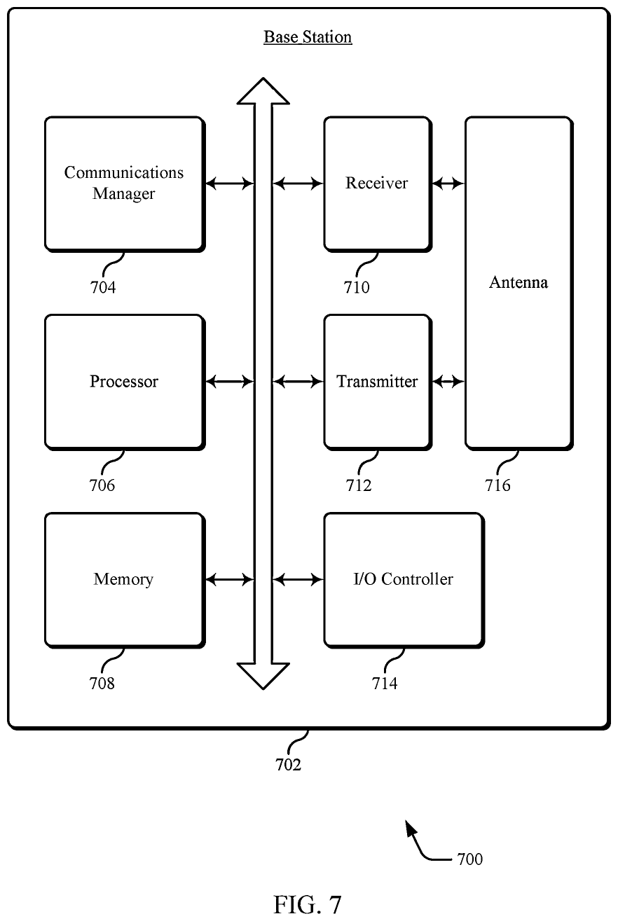

FIG. 7 illustrates an example of a block diagram 700 of a device 702 that supports signaling slice information to a device in accordance with aspects of the present disclosure. The device 702 may be an example of a base station 102, such as a gNB as described herein. The device 702 may support wireless communication and/or network signaling with one or more base stations 102, other UEs 104, core network devices and functions (e.g., core network 106), or any combination thereof. The device 702 may include components for bi-directional communications including components for transmitting and receiving communications, such as a communications manager 704, a processor 706, a memory 708, a receiver 710, a transmitter 712, and an I/O controller 714. These components may be in electronic communication or otherwise coupled (e.g., operatively, communicatively, functionally, electronically, electrically) via one or more interfaces (e.g., buses).

The communications manager 704, the receiver 710, the transmitter 712, or various combinations thereof or various components thereof may be examples of means for performing various aspects of the present disclosure as described herein. For example, the communications manager 704, the receiver 710, the transmitter 712, or various combinations or components thereof may support a method for performing one or more of the functions described herein.

In some implementations, the communications manager 704, the receiver 710, the transmitter 712, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 706 and the memory 708 coupled with the processor 706 may be configured to perform one or more of the functions described herein (e.g., by executing, by the processor 706, instructions stored in the memory 708).

Additionally or alternatively, in some implementations, the communications manager 704, the receiver 710, the transmitter 712, or various combinations or components thereof may be implemented in code (e.g., as communications management software or firmware) executed by the processor 706. If implemented in code executed by the processor 706, the functions of the communications manager 704, the receiver 710, the transmitter 712, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 704 may be configured to perform various operations (e.g., receiving, monitoring, transmitting) using or otherwise in cooperation with the receiver 710, the transmitter 712, or both. For example, the communications manager 704 may receive information from the receiver 710, send information to the transmitter 712, or be integrated in combination with the receiver 710, the transmitter 712, or both to receive information, transmit information, or perform various other operations as described herein. Although the communications manager 704 is illustrated as a separate component, in some implementations, one or more functions described with reference to the communications manager 704 may be supported by or performed by the processor 706, the memory 708, or any combination thereof. For example, the memory 708 may store code, which may include instructions executable by the processor 706 to cause the device 702 to perform various aspects of the present disclosure as described herein, or the processor 706 and the memory 708 may be otherwise configured to perform or support such operations.

For example, the communications manager 704 may support wireless communication and/or network signaling at a device (e.g., the device 702, a base station) in accordance with examples as disclosed herein. The communications manager 704 and/or other device components may be configured as or otherwise support an apparatus, such as a base station, including a transceiver; a processor coupled to the transceiver, the processor and the transceiver configured to cause the apparatus to: transmit, to a UE using broadcast signaling, a first signaling indicating first slice information and a first cell list, the first slice information identifying one or more slice groups supported by a frequency, and the first cell list identifying a first one or more cells supporting the one or more slice groups; and transmit, to the UE using dedicated signaling, a second signaling indicating second slice information that identifies one or more slice groups supported by the frequency.

Additionally, the apparatus (e.g., a base station) includes any one or combination of: where the first slice information includes a frequency priority mapping for each of multiple slice groups supported by a current serving cell for the UE or by at least one neighboring cell; where the first slice information includes a first cell reselection priority corresponding to one slice group of the one or more slice groups for the frequency, and the second slice information includes a second cell reselection priority corresponding to the one slice group; where the second signaling comprises a RRCRelease message; where the first cell list is an allowed list that lists one or more cells supporting the one or more slice groups; where the first cell list is an excluded list that lists one or more cells that do not support the one or more slice groups; where the first signaling indicates, for each of a first set of multiple frequencies, the first slice information and the first cell list, the first slice information identifying one or more slice groups supported by the frequency, and the first cell list identifying the first one or more cells supporting the one or more slice groups for the frequency; where the second signaling indicates, for each of a second set of multiple frequencies, the first slice information and the first cell list, the first slice information identifying one or more slice groups supported by the frequency, and the first cell list identifying the first one or more cells supporting the one or more slice groups for the frequency, and where the first set of multiple frequencies includes a particular frequency that is not included in the second set of multiple frequencies; where the second signaling further receives a second cell list identifying one or more cells supporting the one or more slice groups, where the first cell list is one of an allowed list that lists the one or more cells supporting the one or more slice groups or an excluded list that lists the one or more cells that do not support the one or more slice groups, and the second cell list is the other of the allowed list or the excluded list.

The communications manager 704 and/or other device components may be configured as or otherwise support a means for wireless communication and/or network signaling at a base station, including transmitting, to a user equipment (UE) using broadcast signaling, a first signaling indicating first slice information and a first cell list, the first slice information identifying one or more slice groups supported by a frequency, and the first cell list identifying a first one or more cells supporting the one or more slice groups; and transmitting, to the UE using dedicated signaling, a second signaling indicating second slice information that identifies one or more slice groups supported by the frequency.

Additionally, wireless communication at the base station includes any one or combination of: where the first slice information includes a frequency priority mapping for each of multiple slice groups supported by a current serving cell for the UE or by at least one neighboring cell; where the first slice information includes a first cell reselection priority corresponding to one slice group of the one or more slice groups for the frequency, and the second slice information includes a second cell reselection priority corresponding to the one slice group; where the second signaling comprises a RRCRelease message; where the first cell list is an allowed list that lists one or more cells supporting the one or more slice groups; where the first cell list is an excluded list that lists one or more cells that do not support the one or more slice groups; where the first signaling indicates, for each of a first set of multiple frequencies, the first slice information and the first cell list, the first slice information identifying one or more slice groups supported by the frequency, and the first cell list identifying the first one or more cells supporting the one or more slice groups for the frequency; where the second signaling indicates, for each of a second set of multiple frequencies, the first slice information and the first cell list, the first slice information identifying one or more slice groups supported by the frequency, and the first cell list identifying the first one or more cells supporting the one or more slice groups for the frequency, and where the first set of multiple frequencies includes a particular frequency that is not included in the second set of multiple frequencies; where the second signaling further receives a second cell list identifying one or more cells supporting the one or more slice groups, where the first cell list is one of an allowed list that lists the one or more cells supporting the one or more slice groups or an excluded list that lists the one or more cells that do not support the one or more slice groups, and the second cell list is the other of the allowed list or the excluded list.

The processor 706 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 706 may be configured to operate a memory array using a memory controller. In some other implementations, a memory controller may be integrated into the processor 706. The processor 706 may be configured to execute computer-readable instructions stored in a memory (e.g., the memory 708) to cause the device 702 to perform various functions of the present disclosure.

The memory 708 may include random access memory (RAM) and read-only memory (ROM). The memory 708 may store computer-readable, computer-executable code including instructions that, when executed by the processor 706 cause the device 702 to perform various functions described herein. The code may be stored in a non-transitory computer-readable medium such as system memory or another type of memory. In some implementations, the code may not be directly executable by the processor 706 but may cause a computer (e.g., when compiled and executed) to perform functions described herein. In some implementations, the memory 708 may include, among other things, a basic I/O system (BIOS) which may control basic hardware or software operation such as the interaction with peripheral components or devices.

The I/O controller 714 may manage input and output signals for the device 702. The I/O controller 714 may also manage peripherals not integrated into the device 702. In some implementations, the I/O controller 714 may represent a physical connection or port to an external peripheral. In some implementations, the I/O controller 714 may utilize an operating system such as iOS®, ANDROID®, MS-DOS®, MS-WINDOWS®, OS/2®, UNIX®, LINUX®, or another known operating system. In some implementations, the I/O controller 714 may be implemented as part of a processor, such as the processor 706. In some implementations, a user may interact with the device 702 via the I/O controller 714 or via hardware components controlled by the I/O controller 714.

In some implementations, the device 702 may include a single antenna 716. However, in some other implementations, the device 702 may have more than one antenna 716, which may be capable of concurrently transmitting or receiving multiple wireless transmissions. The receiver 710 and the transmitter 712 may communicate bi-directionally, via the one or more antennas 716, wired, or wireless links as described herein. For example, the receiver 710 and the transmitter 712 may represent a wireless transceiver and may communicate bi-directionally with another wireless transceiver. The transceiver may also include a modem to modulate the packets, to provide the modulated packets to one or more antennas 716 for transmission, and to demodulate packets received from the one or more antennas 716.

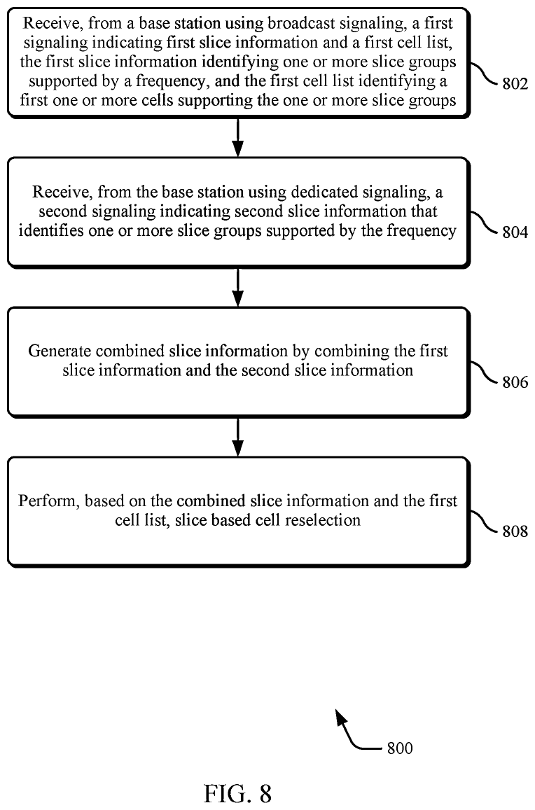

FIG. 8 illustrates a flowchart of a method 800 that supports signaling slice information to a device in accordance with aspects of the present disclosure. The operations of the method 800 may be implemented and performed by a device or its components, such as a UE 104 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 802, the method may include receiving, from a base station using broadcast signaling, a first signaling indicating first slice information and a first cell list, the first slice information identifying one or more slice groups supported by a frequency, and the first cell list identifying a first one or more cells supporting the one or more slice groups. The operations of 802 may be performed in accordance with examples as described herein. In some implementations, aspects of the operations of 802 may be performed by a device as described with reference to FIG. 1.

At 804, the method may include receiving, from the base station using dedicated signaling, a second signaling indicating second slice information that identifies one or more slice groups supported by the frequency. The operations of 804 may be performed in accordance with examples as described herein. In some implementations, aspects of the operations of 804 may be performed by a device as described with reference to FIG. 1.

At 806, the method may include generating combined slice information by combining the first slice information and the second slice information. The operations of 806 may be performed in accordance with examples as described herein. In some implementations, aspects of the operations of 806 may be performed by a device as described with reference to FIG. 1.

At 808, the method may include performing, based on the combined slice information and the first cell list, slice based cell reselection. The operations of 808 may be performed in accordance with examples as described herein. In some implementations, aspects of the operations of 808 may be performed by a device as described with reference to FIG. 1.

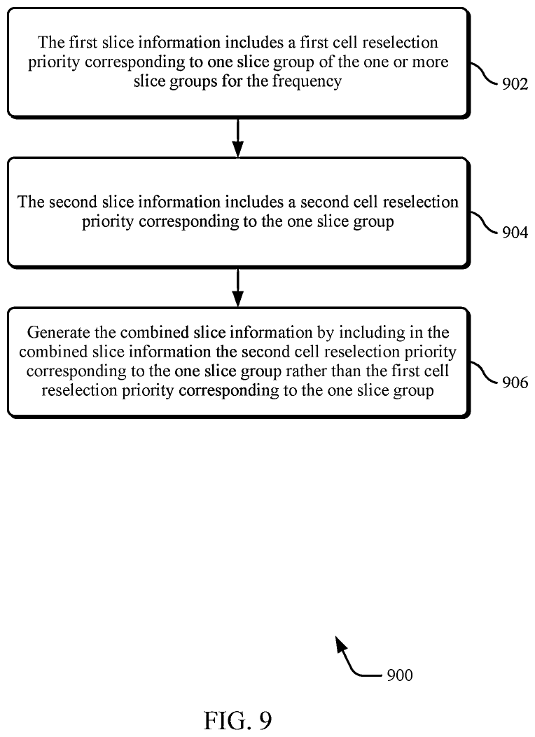

FIG. 9 illustrates a flowchart of a method 900 that supports signaling slice information to a device in accordance with aspects of the present disclosure. The operations of the method 900 may be implemented and performed by a device or its components, such as a UE 104 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 902, the method may include the first slice information includes a first cell reselection priority corresponding to one slice group of the one or more slice groups for the frequency. The operations of 902 may be performed in accordance with examples as described herein. In some implementations, aspects of the operations of 902 may be performed by a device as described with reference to FIG. 1.

At 904, the method may include the second slice information includes a second cell reselection priority corresponding to the one slice group. The operations of 904 may be performed in accordance with examples as described herein. In some implementations, aspects of the operations of 904 may be performed by a device as described with reference to FIG. 1.

At 906, the method may include generating the combined slice information by including in the combined slice information the second cell reselection priority corresponding to the one slice group rather than the first cell reselection priority corresponding to the one slice group. The operations of 906 may be performed in accordance with examples as described herein. In some implementations, aspects of the operations of 906 may be performed by a device as described with reference to FIG. 1.

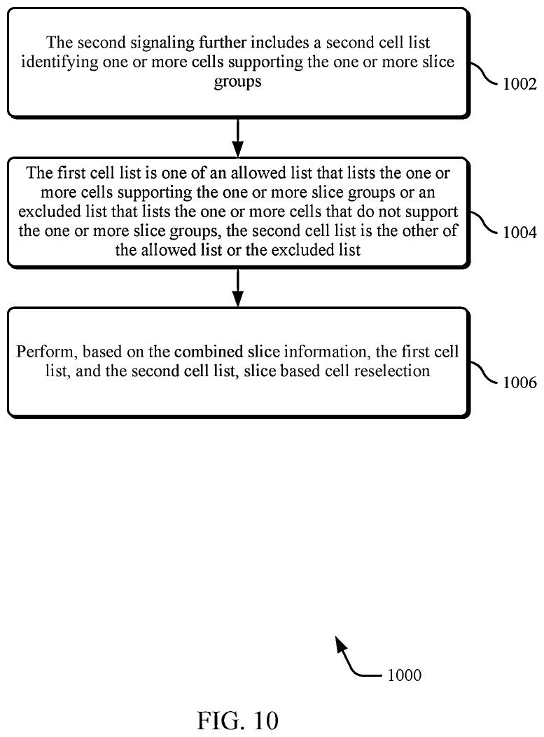

FIG. 10 illustrates a flowchart of a method 1000 that supports signaling slice information to a device in accordance with aspects of the present disclosure. The operations of the method 1000 may be implemented and performed by a device or its components, such as a UE 104 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1002, the method may include the second signaling further includes a second cell list identifying one or more cells supporting the one or more slice groups. The operations of 1002 may be performed in accordance with examples as described herein. In some implementations, aspects of the operations of 1002 may be performed by a device as described with reference to FIG. 1.

At 1004, the method may include the first cell list is one of an allowed list that lists the one or more cells supporting the one or more slice groups or an excluded list that lists the one or more cells that do not support the one or more slice groups, the second cell list is the other of the allowed list or the excluded list. The operations of 1004 may be performed in accordance with examples as described herein. In some implementations, aspects of the operations of 1004 may be performed by a device as described with reference to FIG. 1.

At 1006, the method may include performing, based on the combined slice information, the first cell list, and the second cell list, slice based cell reselection. The operations of 1006 may be performed in accordance with examples as described herein. In some implementations, aspects of the operations of 1006 may be performed by a device as described with reference to FIG. 1.

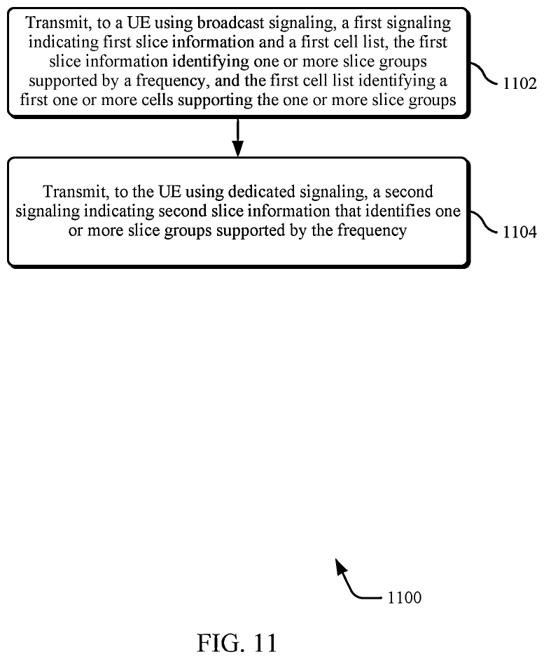

FIG. 11 illustrates a flowchart of a method 1100 that supports signaling slice information to a device in accordance with aspects of the present disclosure. The operations of the method 1100 may be implemented and performed by a device or its components, such as a base station 102 as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1102, the method may include transmitting, to a UE using broadcast signaling, a first signaling indicating first slice information and a first cell list, the first slice information identifying one or more slice groups supported by a frequency, and the first cell list identifying a first one or more cells supporting the one or more slice groups. The operations of 1102 may be performed in accordance with examples as described herein. In some implementations, aspects of the operations of 1102 may be performed by a device as described with reference to FIG. 1.

At 1104, the method may include transmitting, to the UE using dedicated signaling, a second signaling indicating second slice information that identifies one or more slice groups supported by the frequency. The operations of 1104 may be performed in accordance with examples as described herein. In some implementations, aspects of the operations of 1104 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined. The order in which the methods are described is not intended to be construed as a limitation, and any number or combination of the described method operations may be performed in any order to perform a method, or an alternate method.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C, or AB or AC or BC, or ABC (i.e., A and B and C). Similarly, a list of one or more of A, B, or C means A or B or C, or AB or AC or BC, or ABC (i.e., A and B and C). Similarly, a list of at least one of A; B; or C means A or B or C, or AB or AC or BC, or ABC (i.e., A and B and C). Similarly, a list of one or more of A; B; or C means A or B or C, or AB or AC or BC, or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
receive, from a base station using broadcast signaling, a first signaling indicating first slice information and a first cell list, the first slice information identifying one or more slice groups supported by a frequency, and the first cell list identifying a first one or more cells supporting the one or more slice groups;
receive, from the base station using dedicated signaling, a second signaling indicating second slice information that identifies one or more slice groups supported by the frequency;
generate combined slice information by combining the first slice information and the second slice information; and
perform, based on the combined slice information and the first cell list, slice based cell reselection.

2. The UE of claim 1, wherein the first slice information includes a first cell reselection priority corresponding to one slice group of the one or more slice groups for the frequency, and the second slice information includes a second cell reselection priority corresponding to the one slice group, and the at least one processor is further configured to cause the UE to:
generate the combined slice information by including in the combined slice information the second cell reselection priority corresponding to the one slice group rather than the first cell reselection priority corresponding to the one slice group.

3. The UE of claim 2, wherein the at least one processor is further configured to cause the UE to:
generate the combined slice information by including in the combined slice information, the first cell list and all slice information in the first slice information other than the first cell reselection priority corresponding to the one slice group.

4. The UE of claim 1, wherein the first slice information includes a frequency priority mapping for each of multiple slice groups supported by a current serving cell for the UE or by at least one neighboring cell.

5. The UE of claim 1, wherein the second signaling comprises a radio resource control (RRC) Release message.

6. The UE of claim 1, wherein the first cell list is an allowed list that lists one or more cells supporting the one or more slice groups.

7. The UE of claim 1, wherein the first cell list is an excluded list that lists one or more cells that do not support the one or more slice groups.

8. The UE of claim 1, wherein the first signaling indicates, for each of a first set of multiple frequencies, the first slice information and the first cell list, the first slice information identifying one or more slice groups supported by the frequency, and the first cell list identifying the first one or more cells supporting the one or more slice groups for the frequency.

9. The UE of claim 8, wherein the second signaling indicates, for each of a second set of multiple frequencies, the first slice information and the first cell list, the first slice information identifying one or more slice groups supported by the frequency, and the first cell list identifying the first one or more cells supporting the one or more slice groups for the frequency, and wherein the first set of multiple frequencies includes a particular frequency that is not included in the second set of multiple frequencies, and the at least one processor is further configured to cause the UE to:
perform, based on the combined slice information and the first cell list, slice based cell reselection without considering the particular frequency.

10. The UE of claim 1, wherein the second signaling further includes a second cell list identifying one or more cells supporting the one or more slice groups, wherein the first cell list is one of an allowed list that lists the one or more cells supporting the one or more slice groups or an excluded list that lists the one or more cells that do not support the one or more slice groups, the second cell list is another of the allowed list or the excluded list, and the at least one processor is further configured to cause the UE to:
perform, based on the combined slice information, the first cell list, and the second cell list, slice based cell reselection.

11. The UE of claim 10, wherein the second signaling further includes a second cell list identifying one or more cells supporting the one or more slice groups, wherein the first cell list is one of an allowed list that lists the one or more cells supporting the one or more slice groups or an excluded list that lists the one or more cells that do not support the one or more slice groups, the second cell list is another of the allowed list or the excluded list, and the at least one processor is further configured to cause the UE to:
determine that a best ranked cell for the frequency is not listed in either of the first cell list or the second cell list;
acquire, in response to the best ranked cell for the frequency not being listed in either of the first cell list or the second cell list, cell system information for the best ranked cell;
perform, based on the combined slice information, the first cell list, and the cell system information for the best ranked cell, slice based cell reselection.

12. A base station for wireless communication, comprising:
at least one memory; and
at least one processor coupled coupled with the at least one memory and configured to cause the base station to:
transmit, to a user equipment (UE) using broadcast signaling, a first signaling indicating first slice information and a first cell list, the first slice information identifying one or more slice groups supported by a frequency, and the first cell list identifying a first one or more cells supporting the one or more slice groups; and
transmit, to the UE using dedicated signaling, a second signaling indicating second slice information that identifies one or more slice groups supported by the frequency.

13. The base station of claim 12, wherein the first slice information includes a frequency priority mapping for each of multiple slice groups supported by a current serving cell for the UE or by at least one neighboring cell.

14. The base station of claim 12, wherein the first slice information includes a first cell reselection priority corresponding to one slice group of the one or more slice groups for the frequency, and the second slice information includes a second cell reselection priority corresponding to the one slice group.

15. The base station of claim 12, wherein the first cell list is an allowed list that lists one or more cells supporting the one or more slice groups.

16. (canceled)

17. (canceled)

18. (canceled)

19. (canceled)

20. A method performed by a user equipment (UE), the method comprising:
receiving, from a base station using broadcast signaling, a first signaling indicating first slice information and a first cell list, the first slice information identifying one or more slice groups supported by a frequency, and the first cell list identifying a first one or more cells supporting the one or more slice groups;
receiving, from the base station using dedicated signaling, a second signaling indicating second slice information that identifies one or more slice groups supported by the frequency;
generating combined slice information by combining the first slice information and the second slice information; and
performing, based on the combined slice information and the first cell list, slice based cell reselection.

21. A processor for wireless communication, comprising:
at least one controller coupled with at least one memory and configured to cause the processor to:
receive, from a base station using broadcast signaling, a first signaling indicating first slice information and a first cell list, the first slice information identifying one or more slice groups supported by a frequency, and the first cell list identifying a first one or more cells supporting the one or more slice groups;
receive, from the base station using dedicated signaling, a second signaling indicating second slice information that identifies one or more slice groups supported by the frequency;
generate combined slice information by combining the first slice information and the second slice information; and
perform, based on the combined slice information and the first cell list, slice based cell reselection.

22. The processor of claim 21, wherein the first slice information includes a first cell reselection priority corresponding to one slice group of the one or more slice groups for the frequency, and the second slice information includes a second cell reselection priority corresponding to the one slice group, and the at least one controller is further configured to cause the processor to:
generate the combined slice information by including in the combined slice information the second cell reselection priority corresponding to the one slice group rather than the first cell reselection priority corresponding to the one slice group.

23. The processor of claim 21, wherein the first slice information includes a frequency priority mapping for each of multiple slice groups supported by a current serving cell for the processor or by at least one neighboring cell.

24. The processor of claim 21, wherein the second signaling comprises a radio resource control (RRC) Release message.
